(19) United States
(12) Patent Application Publication
(10) Pub. No.: US 2014/0344185 A1
(43) Pub. Date: Nov. 20, 2014

(54) SYSTEM AND METHOD FOR DEVELOPMENT OF FINANCIAL PLANS

(71) Applicant: InStream Solution, LLC, McLean, VA (US)

(72) Inventor: Alejandro Murguia, Alexandria, VA (US)

(21) Appl. No.: 14/216,531

(22) Filed: Mar. 17, 2014

Related U.S. Application Data
(60) Provisional application No. 61/788,393, filed on Mar. 15, 2013.

(51) Int. Cl. G06Q 40/06

(52) U.S. Cl. CPC G06Q 40/06
USPC 705/36 R

(57) ABSTRACT

A system and method for development of financial plans includes computer readable program code to execute a in which, on a daily basis, a comprehensive review is performed for each of a plurality of a financial advisor's clients and an updated financial plan is generated based on the comprehensive review. On a daily basis, a series of alerts are generated based on the comprehensive review, the alerts indicating to a financial advisor which of the advisor's clients should be contacted. The series of alerts are then transmitted to the financial advisor.

This application is a non-provisional of and claims priority to U.S. Provisional Patent Application No. 61/788,393 filed Mar. 15, 2013, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a screenshot illustrating a user interface to a peer planning feature of the disclosed system.

FIG. 2 is a diagram illustrating a mind map in accordance a disclosed embodiment.

FIG. 3 shows a screenshot illustrating how a database view transforms into a mindmap.

FIG. 4 shows a screenshot illustrating a real time update from a database to a mind map all within one system.

FIGS. 5-7 show screenshots illustrating marketplace workflow in accordance with an embodiment of the disclosed system.

FIG. 8 shows a screenshot illustrating the present system's interface integrated inside of a plan Recordkeeper.

FIGS. 9-11 show screenshots illustrating a function whereby an advisor is able to open up the presently disclosed application and view 401k plan activity that is coming from another platform.

FIG. 12 shows a screenshot illustrating a user interface allowing an advisor to act on the information from another platform within the present system via an alert system.

FIGS. 13-14 show screenshots illustrating a user interface with pre-set communication preferences.

FIG. 15 shows a screenshot illustrating a user interface having a one-click roll-over feature.

FIGS. 16-24 show screenshots illustrating user interfaces to General Plan Data, Benchmarking, Plan Demographics, Investment Lineup Review, Plan Asset Characteristics, Fee Disclosures, Participant Summary, and Annual Compliance features.

FIG. 25 shows a screenshot illustrating a user interface wherein an advisor fills in company of employment or the information is automatically transferred over from another database.

FIG. 26 shows a screenshot illustrating a function wherein the present system can be integrated with a 5500 database and can identify and bring up the client's/prospect plan records.

FIGS. 27 and 28 show screenshots illustrating a user interface wherein once the connection is made, a plan review and proposal is at the ready.

FIG. 29 shows a screenshot illustrating a function wherein an advisor is able to select pre-set thresholds to identify plan proposal opportunities.

FIG. 30 shows a screenshot illustrating a function wherein an advisor receives an alert about the opportunity.

FIGS. 31 and 32 show screenshots illustrating a safe savings planning module.

FIGS. 33 and 34 show screenshots illustrating a distribution planning module.

FIG. 35 shows a screenshot illustrating a client portal.

FIGS. 36 and 37 show screenshots illustrating a funded ratio function.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to screen shots and diagrams illustrating operational examples of methods and devices for development of financial plans. It is understood that each screenshot, block or operational illustration may be implemented by means of analog or digital hardware and computer program instructions. These computer program instructions may be stored on computer-readable media and provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

### Peer Planning Feature

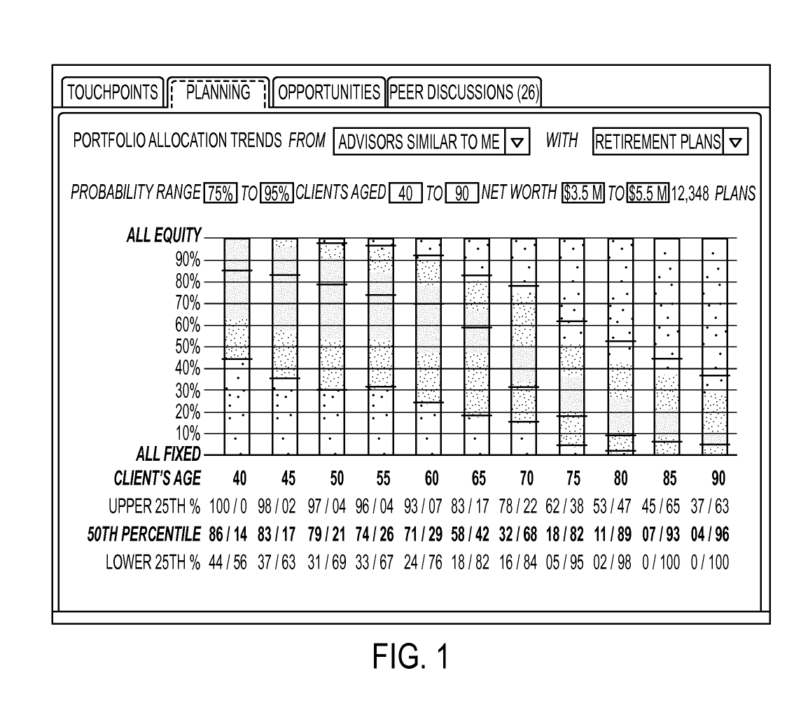

FIG. 1 illustrates a novel peer planning feature in accordance with one aspect of the invention. One objective of this feature is to provide advisors with the ability to create financial plans and/or provide client advice based on what other advisors are doing within the present system's planning platform. As can be seen in FIG. 1, the database is able to indicate to advisors what advice should be dispensed based on what other like-minded advisors are doing for similar clients. The present system can also make recommendations regarding specific financial planning products/solutions according to the issues being addressed.

As users create financial plans in the present system, we want to look at why a particular plan was created, how it was created, and what actions might have resulted from that plan. With that data, across all of the users in the application, the system looks to find commonalities and suggest to users why others have created a plan, what they did when creating that plan, and what actions they took.

What an advisor does in the everyday course of business:

College Planning example:

A client has just had a baby. The advisor creates an education plan. In that education plan, the advisor has included a 529 account that is being funded for a certain amount of money that is equivalent to a percentage of the future estimated tuition at a desired college (e.g., Harvard), 18 years from now. The client also makes recurring contributions, and those contributions equal a certain percentage of the current tuition at the school. The portfolio allocation models used through the life of the plan steadily decreases the equity portion of the portfolio. The plan returns a probability of success that the advisor deems appropriate (e.g., 85% probability).

The peer planning feature will look at this education plan and similar plans that other users have created on the present system's application, and will give information such as:
The age at which point a client has opened a 529 account for a child;
The average amount of money used to fund a 529 account for clients of a similar Net Worth and for similar expected tuitions, that returned a probability of success of 75-85%;
The average annual 529 contributions for similar expected tuitions that returned a probability of success of 75-85%;
The typical allocation glide path used in similar Education plans—looking at the intervals at which equity is decreased, and looking at the actual equity to fixed income exposure used;
If the probability of success were lower or higher than a certain threshold range, suggestions would be made about what other advisors have used to make a successful education plan.

The peer planning feature also acts as an intelligent alert system that tells the advisor that he/she may want to consider a certain strategy for a client based on what they or other like-minded advisors have done for clients with similar demographic and financial characteristics.

As an example, the advisor opens the presently disclosed application (or a notification) and there is an alert indicating that a client's child has turned 6 years old and that 80% of clients whose children are 6 years old begin funding a 529 plan. (The age and 80% thresholds are default arbitrary thresholds that can be modified.)

The advisor then decides to act on the alert and reach out to the client to establish a 529 plan.

The analytics go on to indicate the appropriate states, allocation, and amount of contributions based on other like-minded clients within the system.

As another example, an advisor may have a client who is a small business owner and is 5 years from retirement. The advisor may want to benchmark what he/she should be doing for that client based on what other advisors are doing. The advisor is able to “follow” other advisors that have similar clients and assess what they are doing.

In addition, the advisor could be alerted on items that may not be currently addressed by him/her but should be based on what other advisors are doing with their clients. In this small business owner example, perhaps there is an alert for the advisor to consider establishing an ESOP plan or a defined contribution plan.

The Peer Planning feature is relevant to any type of financial planning (e.g., insurance, cash management, estate planning) It may be used for Retirement plans or even holistic plans. The idea is to look at the demographics and other details of a client, see what events might have triggered the creation of the plan, how the plan was created, see what the results were, see what changes might have been made, see whether the plan is being tracked by the advisor on a regular basis, see what actions might have come out of that plan, and to then look at this information across all similar plans in order to give the user a better idea about how the user's peers are planning for their clients. And finally, it is able to make recommendations to advisors for their clients based on what they or other advisors are doing for a similar set of clients.

### Tracking Plans Feature

One objective of the tracking plans feature is to provide the ability to automate the financial planning process. Using the present system, financial plans can be created using accounts that are updated daily through automated web services. Once a Monte Carlo plan has been created, the user can make that plan a tracking plan by establishing a threshold range. On a nightly basis (or advisor selected interval), the present system runs the plan through the Monte Carlo engine to determine the new probability of success. As account values fluctuate due to market movement, contributions, and distributions, a plan's probability of success can change. By making the plan a Tracking Plan, the user does not need to update the plan's account values, for example, and can be confident that the plan is running nightly with current data. If the probability of success falls outside of the defined threshold range, the user is notified that the client's plan has breached the threshold. The settings around the notification of the breach are user-defined.

The notifications of the threshold breach can be pre-set as some priority, such as Critical, High, Medium, or low; and typically the user will choose the priority based upon the client and the threshold range set. However, the priority of the notification may also be smartly determined. In this way, depending on how far outside of the range the probability falls on any given night, the present system will determine if the breach is Critical, High, Medium, or Low. For example, if the threshold is 85-95%, then a plan that falls from 96-100% will be a low priority; a plan that falls from 75-84% is Medium; a plan that falls from 65-74% is High; and anything less than 64% is Critical. The smart priority adjusts depending on the threshold range that is established.

In addition, the present system can reverse engineer the Monte Carlo probability scores in order to make portfolio recommendations and changes to the advisor. For example, the present system can identify that a current plan has a stated probability of success (e.g., 65%) that can improve to 85% if the advisor adjusts key planning variables such as retirement age, portfolio allocation, cash flows, or other planning related metrics. Key input variables may be pre-determined by advisor decision tree.

### Mind-Map Feature

One objective of the mind-map feature is to provide the ability to provide a visual representation of business data in a continually updated mind map view. As data is entered into a client's database profile, the present system automatically draws upon that data to populate a visual mind-map of the client's profile. This automation of the mind-map ensures that a current visual mind-map is always available as the client profile database is edited or automatically updated. The mind map can be used to navigate through the application, but also can be printed for presentation. This automatically created mind-map would be used for all of the data, assumptions, and analysis results that are relevant to a client. The mind map would also be used as a timeline, wealth management log to indicate what previous and current planning issues have been addressed, and what future issues may need to be addressed by the advisor and client.

Essentially, it is a continually updated view of a client information database displayed as a mind map.

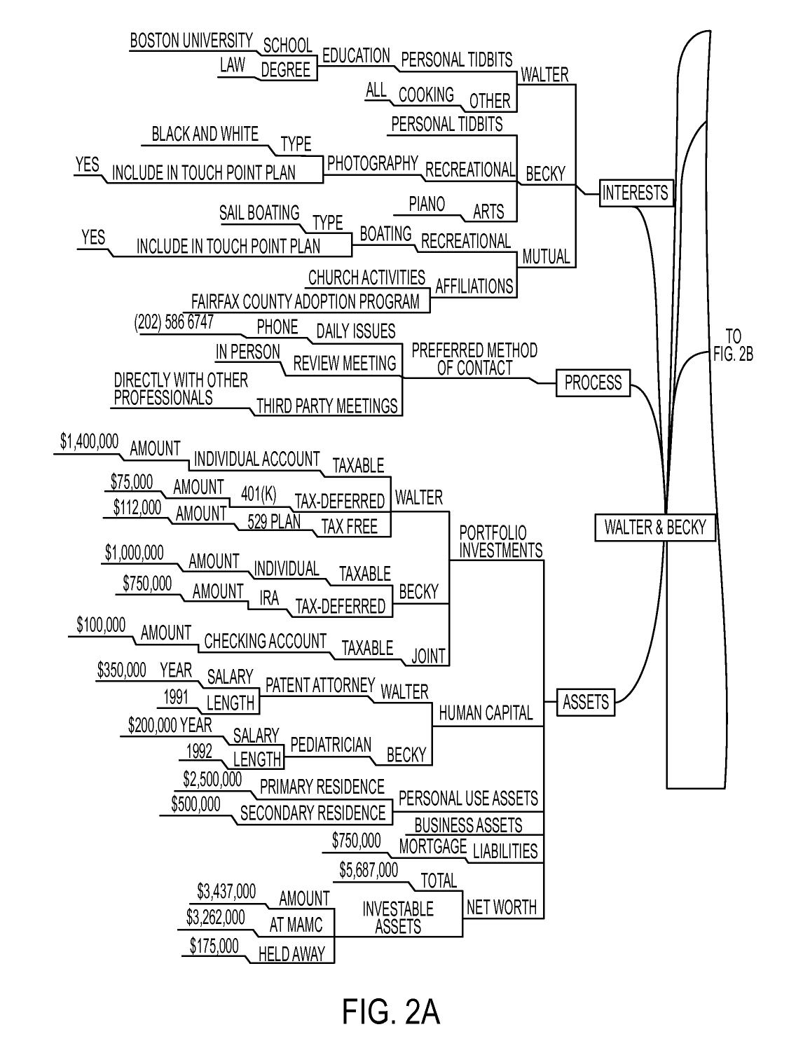

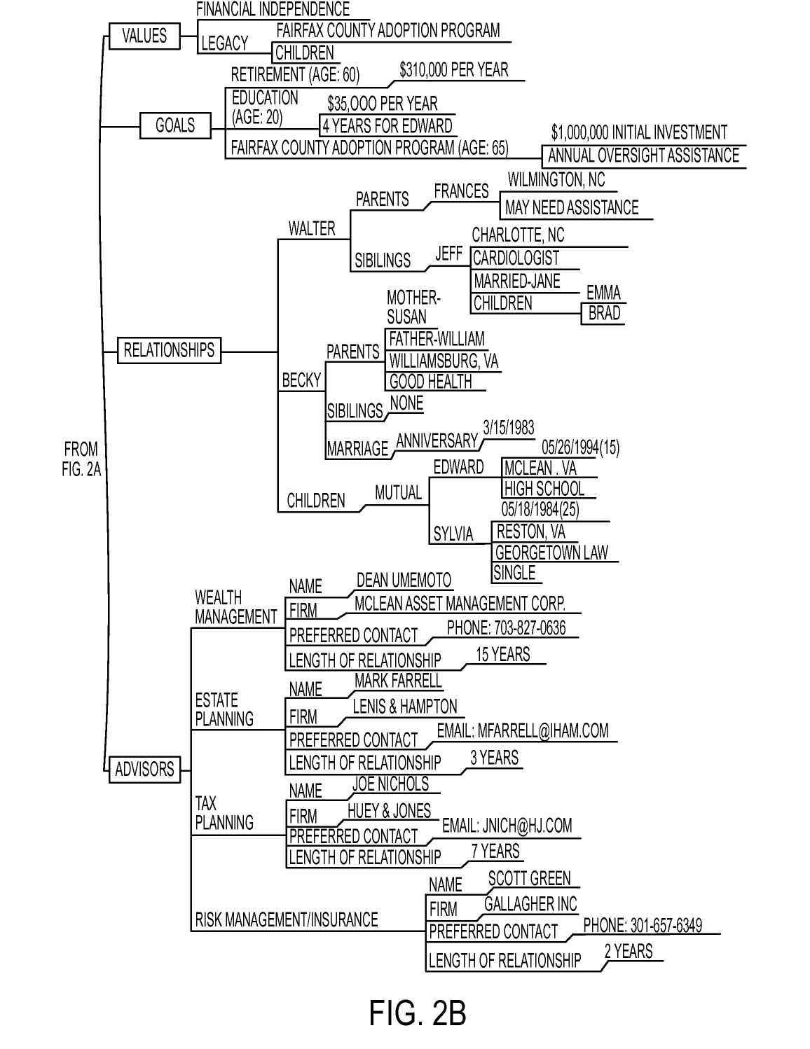

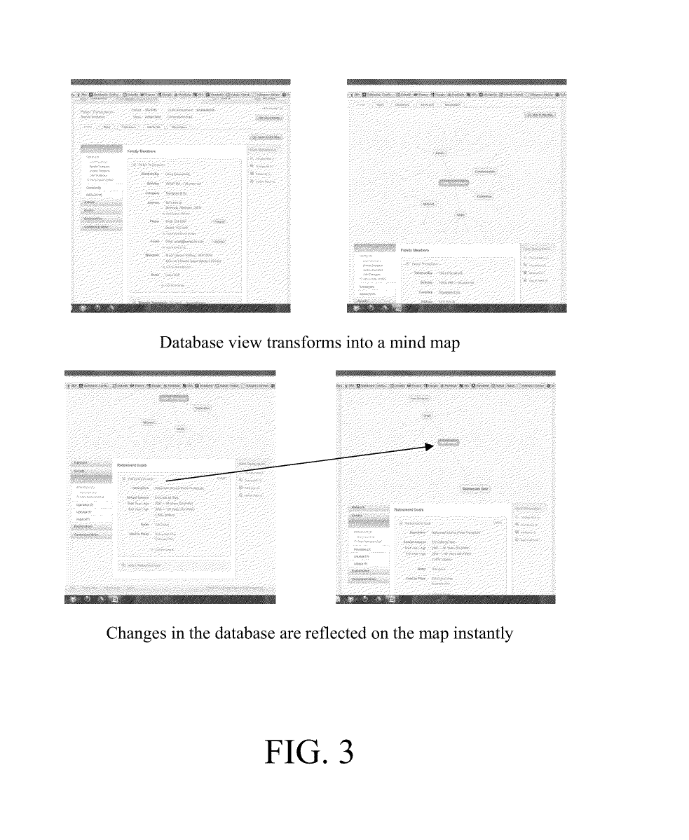

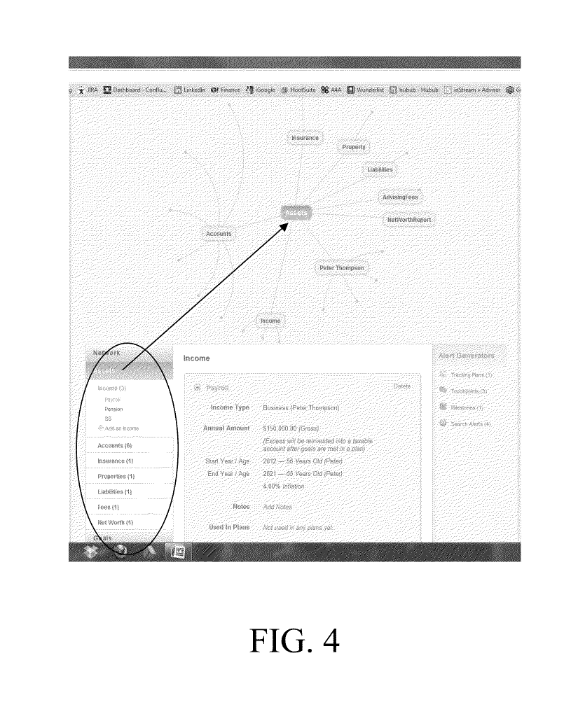

FIG. 2 shows a mind map view of a client's wealth landscape and wealth management log. FIG. 3 shows screenshots illustrating how a database view transforms into a mindmap. FIG. 4 shows a screenshot illustrating a real time update from a database to a mind map all within one system. In this respect, the mind map provides an alternative way of conceptualizing the data.

### Financial Advisor Marketplace

In an embodiment, the disclosed system and method provides a unique marketplace architecture allows its subscribers to either provide their advisors with access to a prepopulated solution (i.e. insurance, mortgage) vendors (where the advisor does not have their own formal vendor relationships) or provide their advisors with access to the advisor's pre-existing solution vendors using the marketplace architecture. Utilizing system-defined and advisor-defined rules, as well as advisor preferences, the financial advisor marketplace proactively identifies and notifies both advisors and their end clients of marketplace opportunities. The target campaign audience may be determined through a number of methods, including a similar “peer planning” approach where opportunities are presented based on suitability, as well as the behavior and decisions of other clients using the system. One objective of the financial advisor marketplace is to provide the ability to provide advisors with an internal financial marketplace of needed solutions for their clients.

As an extension to the peer planning or independent of it, the present system's financial marketplace is able to identify solutions for clients and make specific product recommendations by bringing within the platform various financial service vendors for advisors. This allows financial advisors to be able to identify, address, and recommend client solutions all from within one platform.

In addition, the workflow between the financial service vendor and the advisor takes place within the platform.

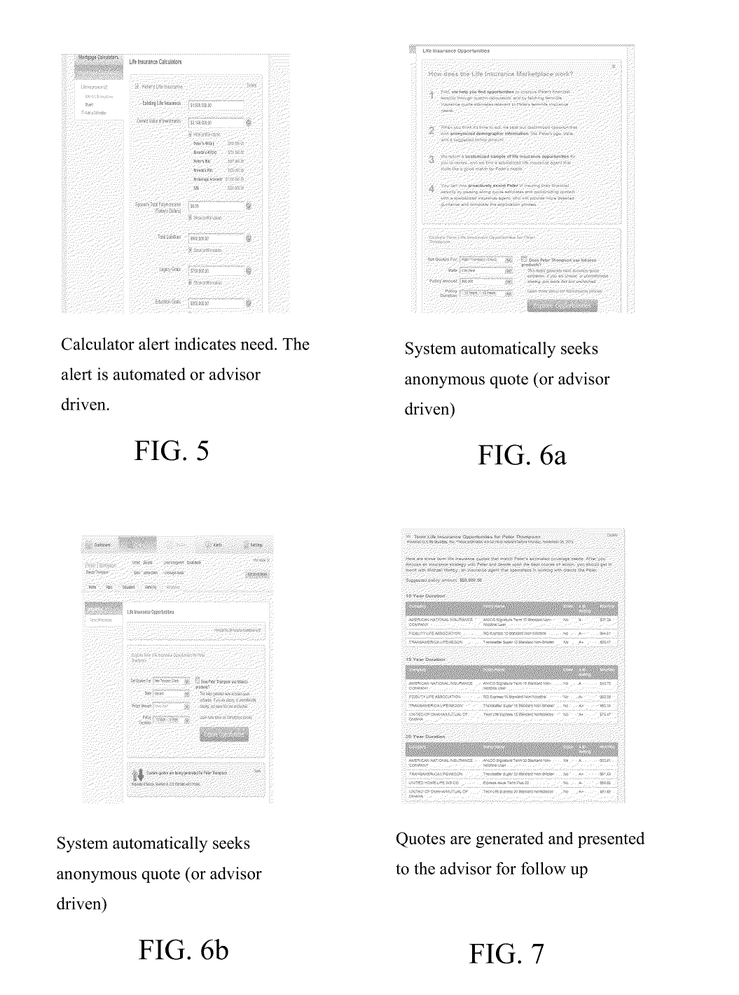

FIGS. 5-7 illustrate the marketplace workflow. In an embodiment, the steps of the workflow are as follows.

1) Advisor receives a Marketplace Alert and/or Advisor directly does a need analysis (e.g., insurance need)

2) Advisor views potential options anonymously generated for the client within the present system

3) Advisor notifies the client of a potential opportunity

4) Client agrees to have the advisor coordinate the process

5) Advisor, within the present system, notifies the financial service vendor

6) Financial service vendor addresses the client need

7) the present system receives payment

8) New offering is automatically entered into the system

9) Advisor receives credit for entering information into the peer planning platform for a potential fee offset Peer Benchmarkings/Social engagement

One objective of the peer benchmarkings/social engagement feature is to provide a financial planning best practices database of financial planning that can be used to help advisors service their clients' financial planning needs and also provide a real time forum in which they can share that information with each other.

The present system's platform collectively accumulates the financial planning knowledge within the system (insurance needs, retirement planning, estate planning, cash management, etc.) and creates a repository of actual approaches utilized by advisors for their clients and subsequent outcomes achieved when addressing financial planning issues. The efficacy of these approaches are tabulated and presented to advisors in order to better serve their ongoing client base.

Advisors on the platform also have the ability to follow the specific planning behaviors of like-minded advisors (through a “follow” feature) in order to maintain awareness of current planning approaches for specific client issues and to create an environment of collaboration.

In addition to planning features, advisors can share and follow other like-minded advisors for practice management related issues and receive real-time benchmarking data.

### Localized Planning Products—“Bespoke Planning”

The present system's platform can specifically identify individuals and/or a subset of individuals within the platform and provide individualized financial solutions to clients based on their demographic information and thus circumventing the traditional application processes in order to access standard financial solutions (e.g., insurance policies) based on general population parameters. For example, present system can identify can a high net worth individual within the system and assess his current credit solutions. Because present system has, within the platform, descriptive information regarding the client it can piece together key variables and propose individual loans and cash management strategies without the need for the traditional requirements such as a credit score, etc. present system can also offer these solutions to clients on the platform on an individual or group basis.

As an example: A client using the present system's platform is offered a better loan rate than what he is currently getting because the intelligence within present system has determined that the client's financial situation has improved to the degree that he presents with a better risk profile than is indicated by the current loan rate.

### Distribution Planning

The system as a whole provides the ability for an advisor to automatically assess the viability of various portfolio distribution strategies for their clients via an automated software platform. One objective of the distributed planning feature is to provide the client with a reasonable estimate of how much a he can distribute from a portfolio successfully throughout a specified time horizon.

For example, present system assesses:

1) Client's liquid net worth; This includes investment securities and cash holdings

2) The potential distributions that the client wants to disperse from his liquid holdings; e.g., 4% of the portfolio securities and cash value.

3) As portfolio distributions are made throughout the year, present system automatically adjusts those pre-specified amounts and notifies advisors of potential changes and suggestions based on potential added contributions to the portfolios, current market fluctuations, and/or takes into consideration increased distributions that were taken out of the portfolio in addition to the expected amount.

4) In addition, the present system allows the advisor to make adjustments to his current client distribution strategy based on the client's previous distribution history/expectation of future withdrawals and current macro-economic variables (e.g., PE ratios, GDP growth, etc.). The present system can also make these adjustment recommendations without advisor input.

This provides a method by which an advisor can track the sustainability of all client distributions across his/her entire firm. This is also automated in a similar manner to tracking plans.

### 401k Component

1) Delivery of Advice Methodology

One objective of this methodology is to provide advisors with the ability that allows plan participants to receive financial planning/investment management advice through the combination two separate delivery platforms for the advisor. The present system can integrate with defined contribution plan interfaces (e.g., a Recordkeeper and Third Party Administrator) and be able to provide plan participants with a financial planning module and a communication portal for the advisor. In addition, the advisor (i.e., plan advisor) will be able, from his/her own interface, to interact with the plan participants and communicate with them across both platforms.

In addition, workflows triggered from one system will be able to initiate actions in another (i.e., cross platform delivery of financial advice workflows). For example, an advisor can be notified of potential communication opportunities (regarding planning advice and/or prospecting) across both systems. The advisor can choose to automate that communication process or insert themselves (via email, phone call, or another form of direct communication) for a more personalized experience depending on pre-set communication preferences.

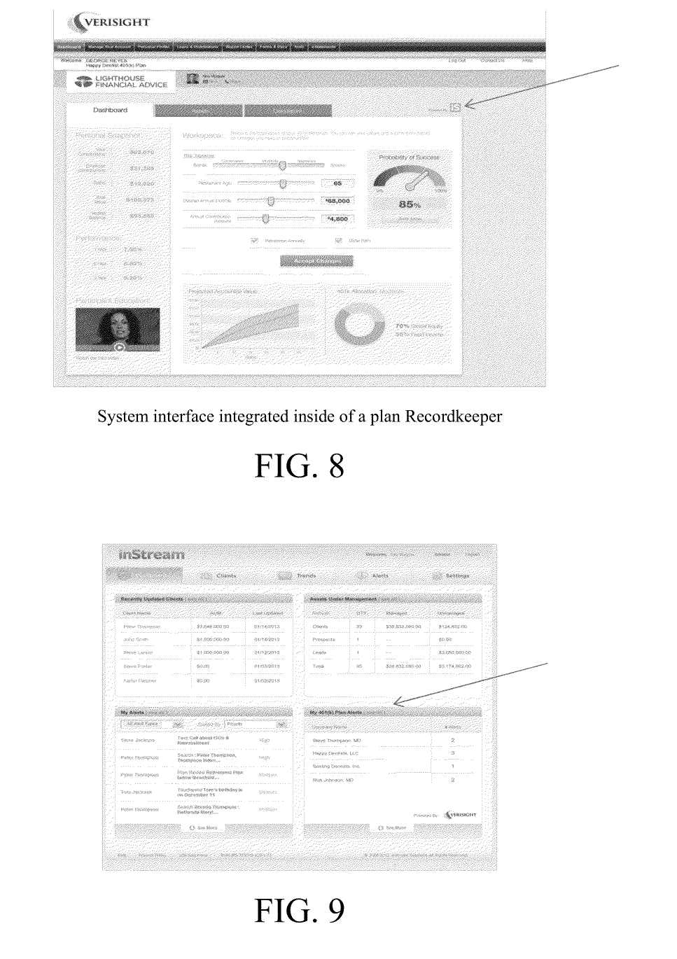

FIG. 8 illustrates the present system's interface integrated inside of a plan recordkeeper.

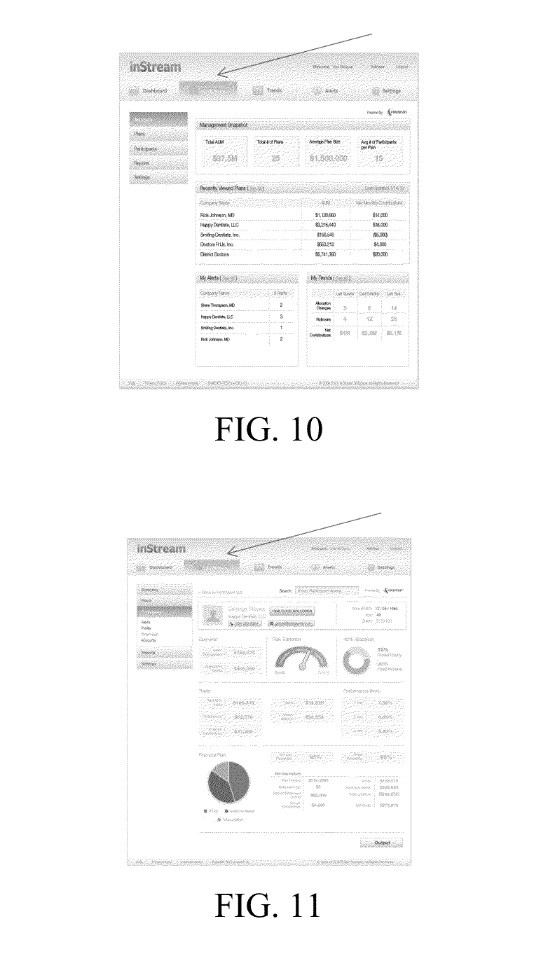

As illustrated in the examples shown in FIGS. 9-11, the advisor is able to open up the presently disclosed application and view 401k plan activity that is coming from another platform (e.g., Recordkeeper).

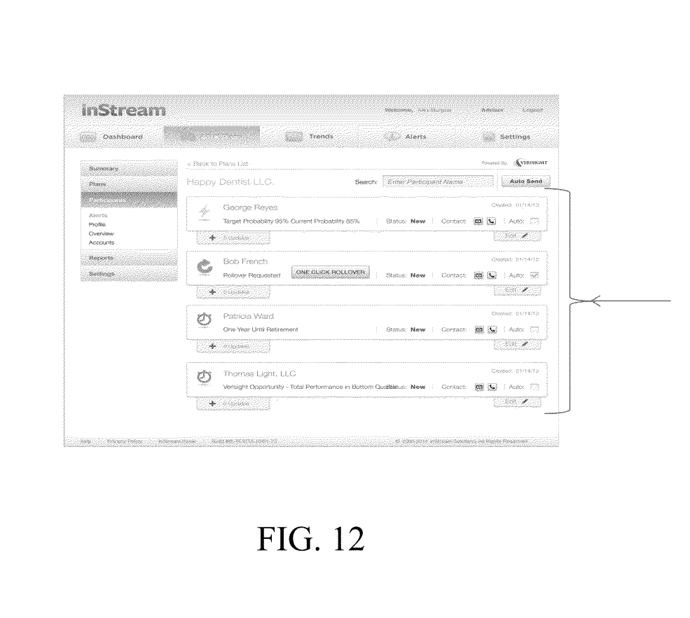

FIG. 12 shows an example wherein the advisor is able to act on the information from the other platform within the present system via an alert system based on pre-set advisor thresholds.

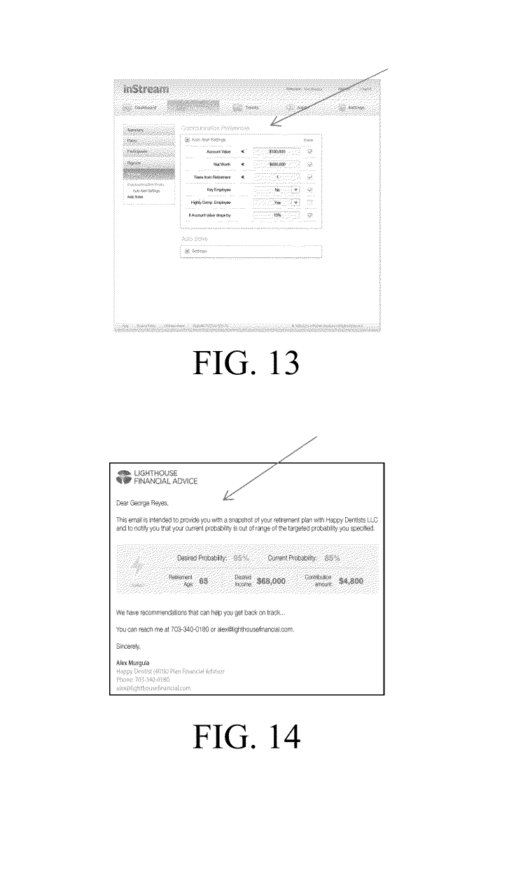

As illustrated in FIGS. 13-14, pre-set communication preferences allow for the ability to personalize or scale up the delivery of plan participant advice and/or communication.

2) One click Roll-Over. Once the advisor has all the pre-set application information at the ready, the participant is able to click one-button in order to initiate and complete an account application and the subsequent transfer of funds. This is initiated when a participant leaves a plan creating an IRA roll-over opportunity at the plan participant level and from the plan recordkeeper's site. The participant has the ability, through a predetermined plan-level agreement, to transfer their account from their plan to a predetermined custodian by pressing one button. An alert is triggered to the advisor on the present platform notifying them that a participant will be transferring an account to their management. This initiates and completes the transfer into the advisor and plan's custodian of choice.

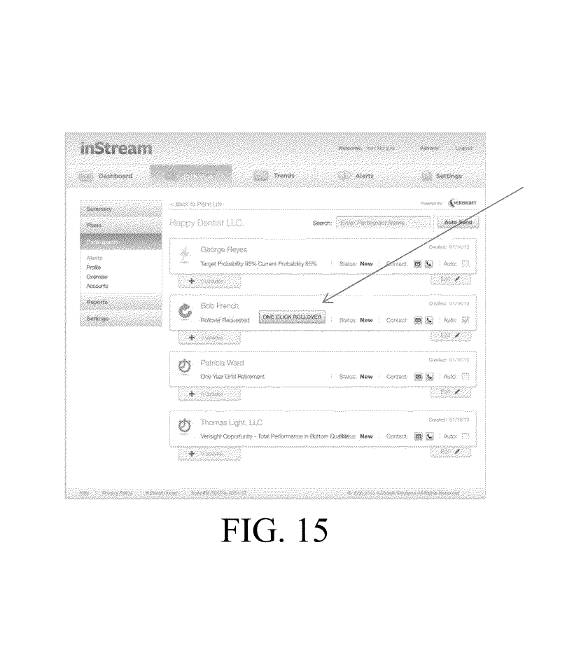

FIG. 15 shows an example of one-click roll-over.

3) Automating a Plan Trustee Reporting system. Within the present system's wealth management platform, we combined significant defined contribution plan oversight. Via the present platform we integrate from disparate databases (e.g., IRS 5500 database, Plan Recordkeeper, Mutual fund reporting service) a combined set of reports that automatically accomplish a plan fiduciaries' reporting requirements. The report combines and automates the creation of the following reporting subsets into one comprehensive output. Examples A through I.

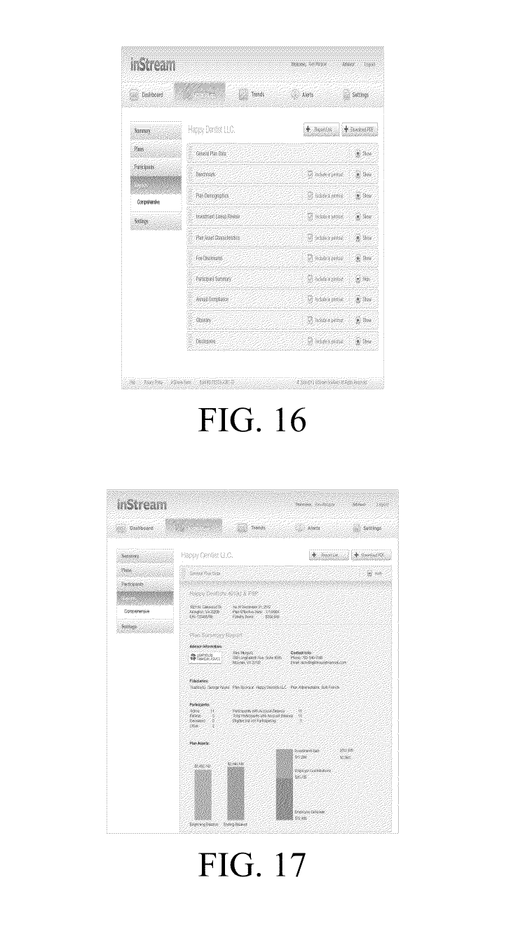

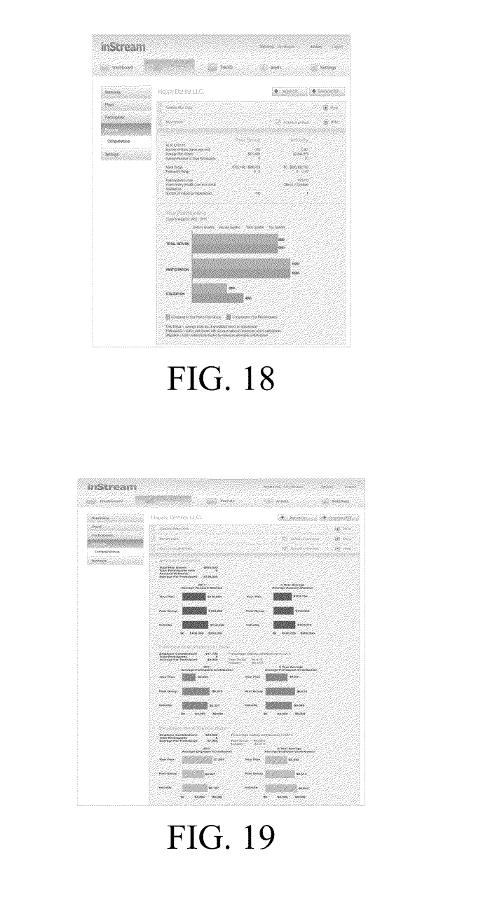

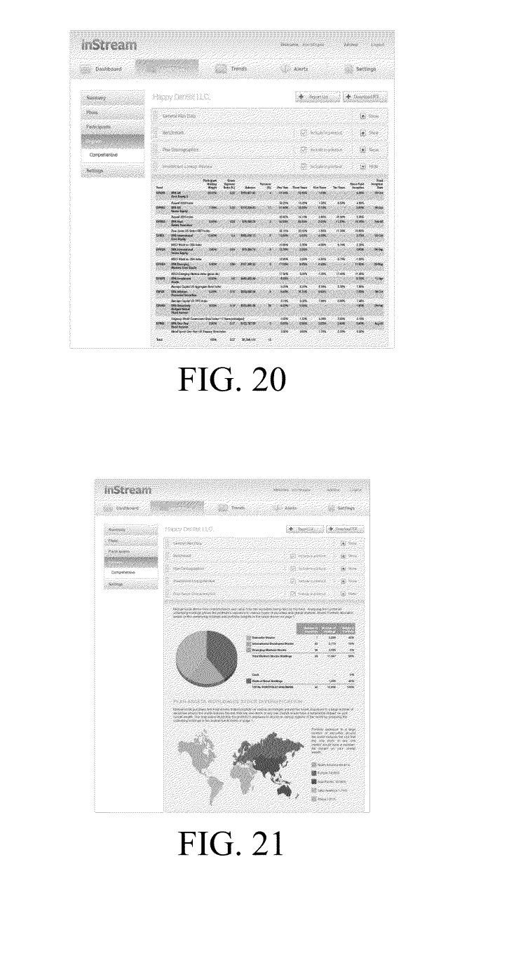

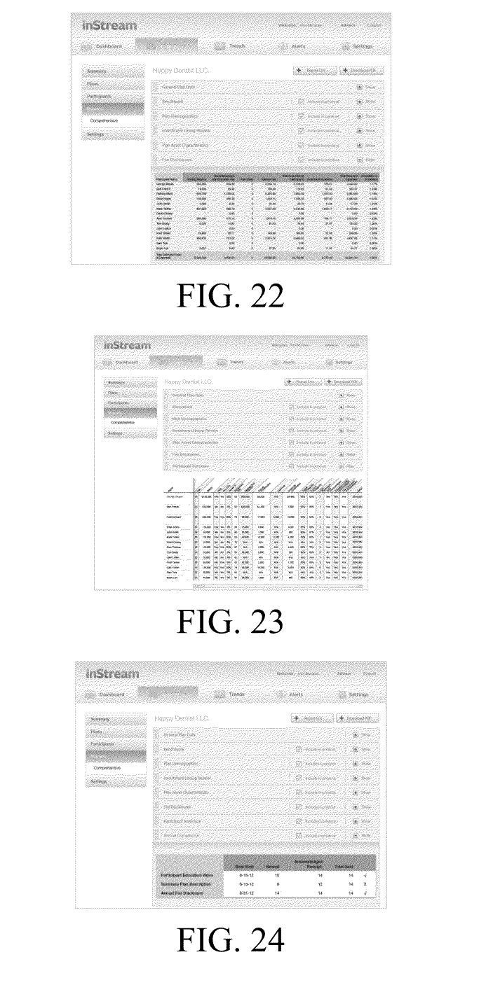

FIGS. 16-24 illustrate General Plan Data, Benchmarking, Plan Demographics, Investment Lineup Review, Plan Asset Characteristics, Fee Disclosures, Participant Summary, Annual Compliance.

4) Defined contribution prospecting from within a contact management, customer relationship management, or financial planning platform. Via the present system as an advisor is entering a client's place of employment (or as that information comes over from an existing database), we are able to match the place of employment with current 5500 data and provide to the advisor an immediate comparison proposal of the clients/prospect plan with the advisor's preferred options. The advisor is also able to define pre-set thresholds in order to be notified when the plan becomes an attractive prospect to the advisor.

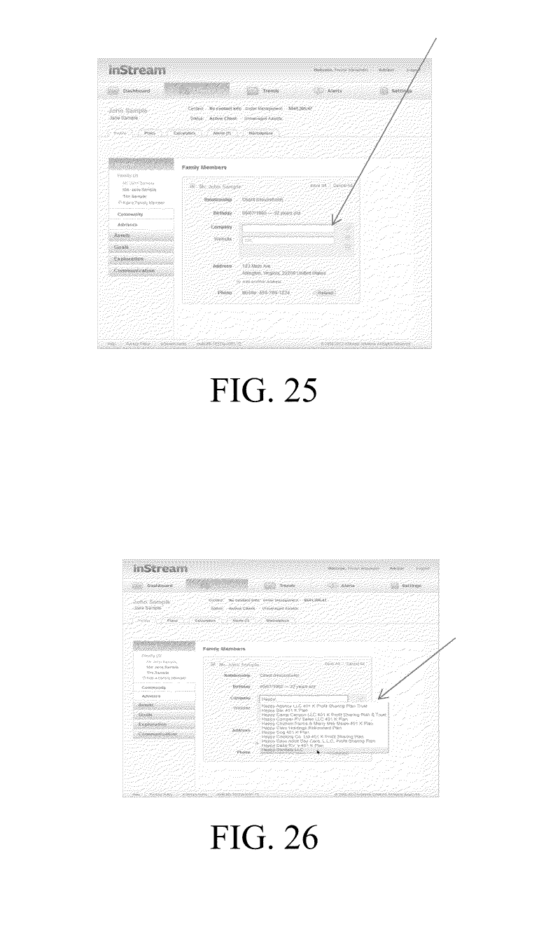

As shown in FIG. 25, the advisor fills in company of employment or the information is automatically transferred over from another database.

As is illustrated in FIG. 26, the present system is integrated with the 5500 database and can identify and bring up the client's/prospect plan records.

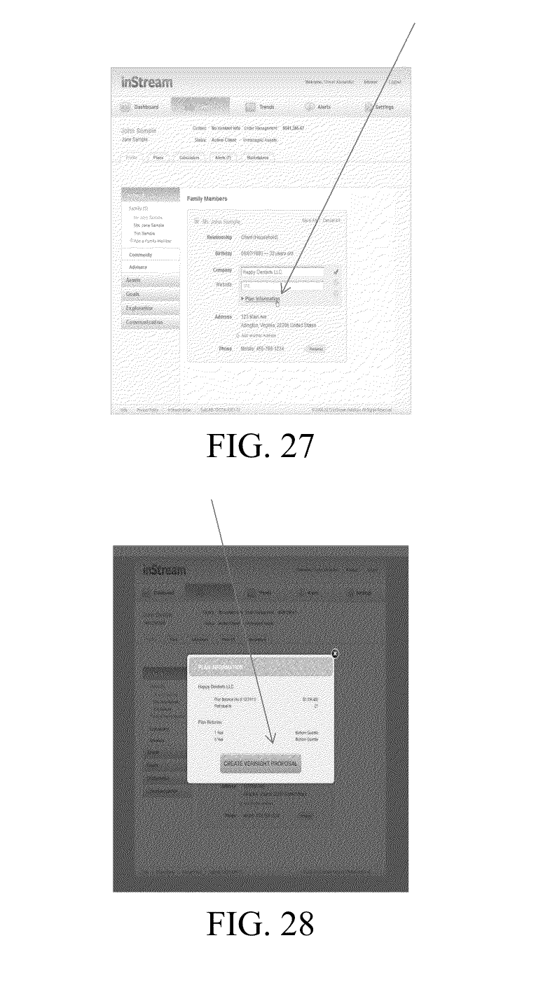

As illustrated in FIGS. 27 and 28, once the connection is made, a plan review and proposal is at the ready.

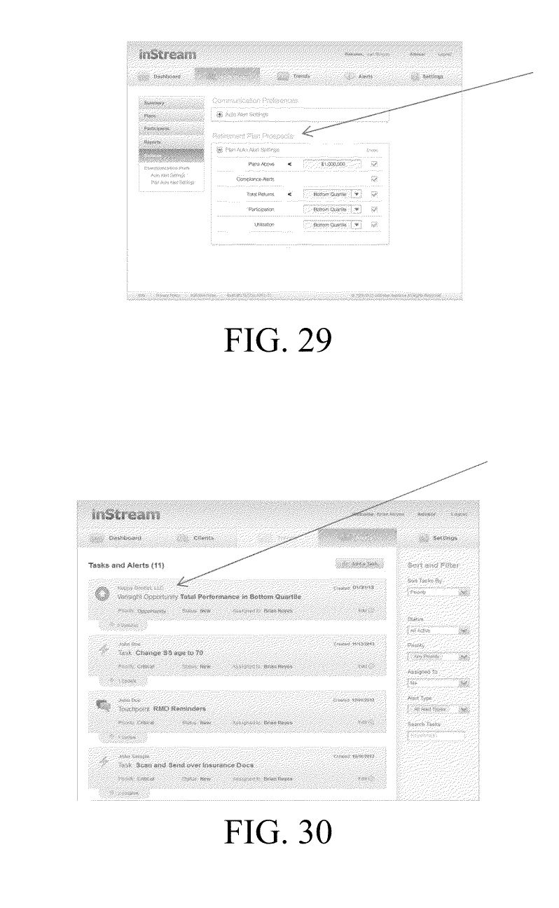

As shown in FIG. 29, an advisor is able to select pre-set thresholds to identify plan proposal opportunities.

As is illustrated in FIG. 30, because the present system reviews and prospects the 5500 database continually, once those pre-set thresholds are met, the advisor receives an alert about the opportunity.

Currently advisors are not able to provide financial planning advice to 401(k) plan participants via a goals-based planning platform. Via the present system, an advisor can integrate both 401(k) plan participant advice and his/her standard non-401(k) advice on a single platform. The present system integrates from the plans recordkeeping platform and provides advisor with a single entry point to provide advice.

By having a single platform providing temporal notifications (e.g., quarterly) to every plan participant based on what their goals and retirement needs are and/or how on track a participant is relative to achieving a retirement goal. By maintaining those files and making suggestions to address potential retirement shortfalls (e.g., improving Monte Carlo scores—see tracking plan). To the extent that advisors assume our model portfolios we have created a software solution that can assume 338 liability (investment discretion) and/or 321 fiduciary liability (i.e., assesses the overall plan structure).

The advisor is also able to pull out census information from the recordkeeper and provide investment advice and marketplace solutions.

### Integrated Financial Advisor Platform

In various embodiments, the disclosed system and method can be configured to perform a complete comprehensive “annual review” for all of an advisor's clients every evening and every morning generate an updated financial plan and series of alerts based on the nightly review that tells the advisor which clients to call and what to discuss with them. The disclosed system and method integrates with an advisor's sources of client data including, for example, Contact Relationship Management (CRM) data, portfolio management data, and custodian data. In this respect, the disclosed system and method greatly facilitates the new users getting started with and adopting the system, and ensures that the client data in the disclosed system is always current. The disclosed system and method allows users to apply industry-leading planning capability along with a series of other sophisticated analytics (e.g., mortgage, insurance, Social Security) to provide an advisor with consistent, timely, relevant insights into the financial profile of each and every one of their clients. The disclosed system and method enables an advisor to efficiently stay in proactive touch with their clients throughout the year and to always begin each conversation with “I was running your numbers last night . . . ”

### Distribution Management System and Planning Modules

The distribution management system of the disclosed system and method can be configured to use a set of advisor-defined rules to dynamically adjust future spending within a client's financial plan. These rules will be dynamically applied based on situations that occur within the simulations of the financial plan, and include, but are not limited to: inflation adjustment, inflation cap, distribution freezes based on investment returns, spending floor, spending ceiling, and prosperity rules. Applications of this system include, but are not limited to: determining the likelihood of success of a desired scenario, determining a maximum sustainable spending amount, and determining a minimum safe savings amount to accomplish a specified objective.

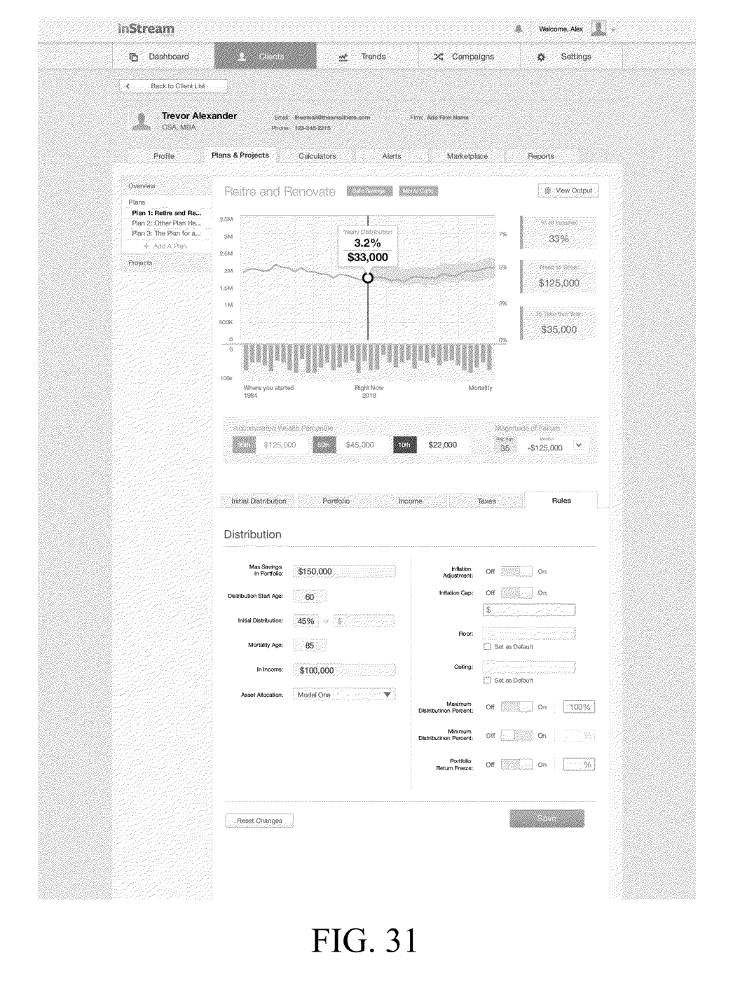

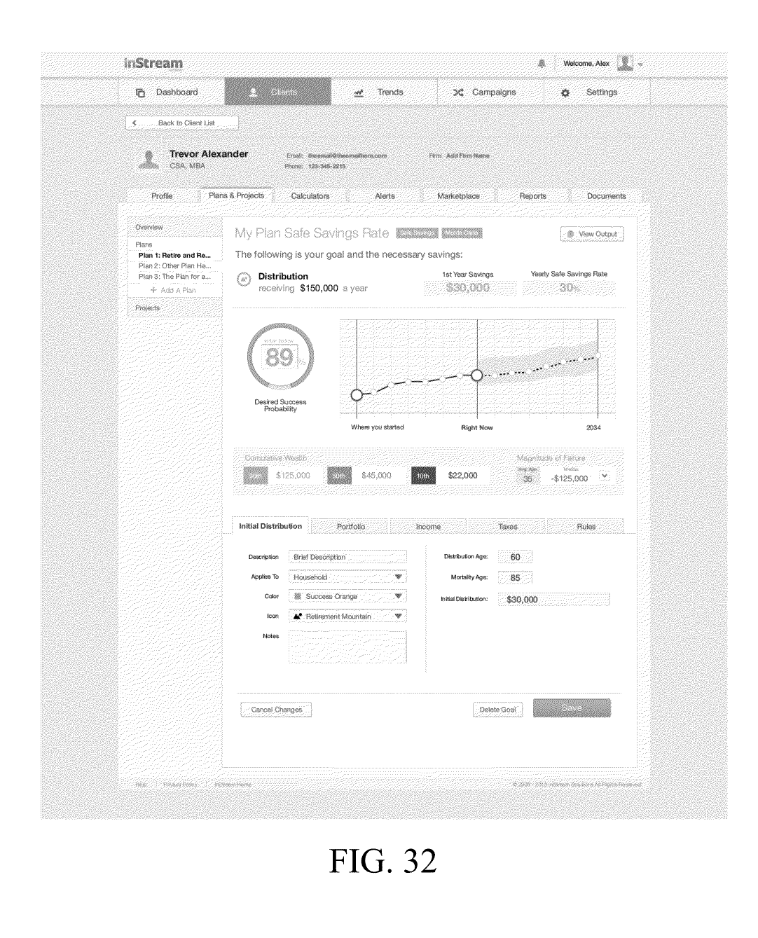

With reference to FIGS. 31 and 32, in an embodiment, the disclosed system and method includes a safe savings rate planning module. The safe savings rate planning module analyzes a client's forward looking situation, and using dynamic distribution rules, determines the necessary amount or percentage of income that should be saved each year to accomplish a spending objective with a specified probability of success. For example, a client would like to take a distribution of $100,000 beginning at age 65. In an embodiment, the safe savings rate analysis determines the percent of income that the client must save each year, until that distribution begins, taking into consideration IRS contribution limits and other advisor-defined assumptions.

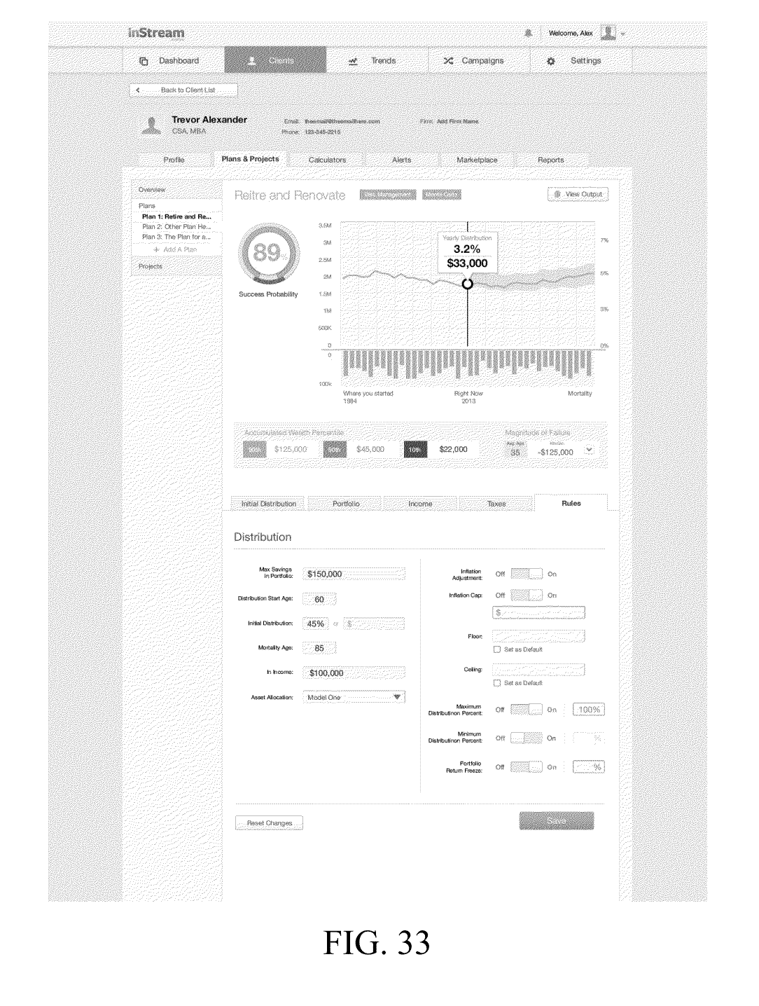

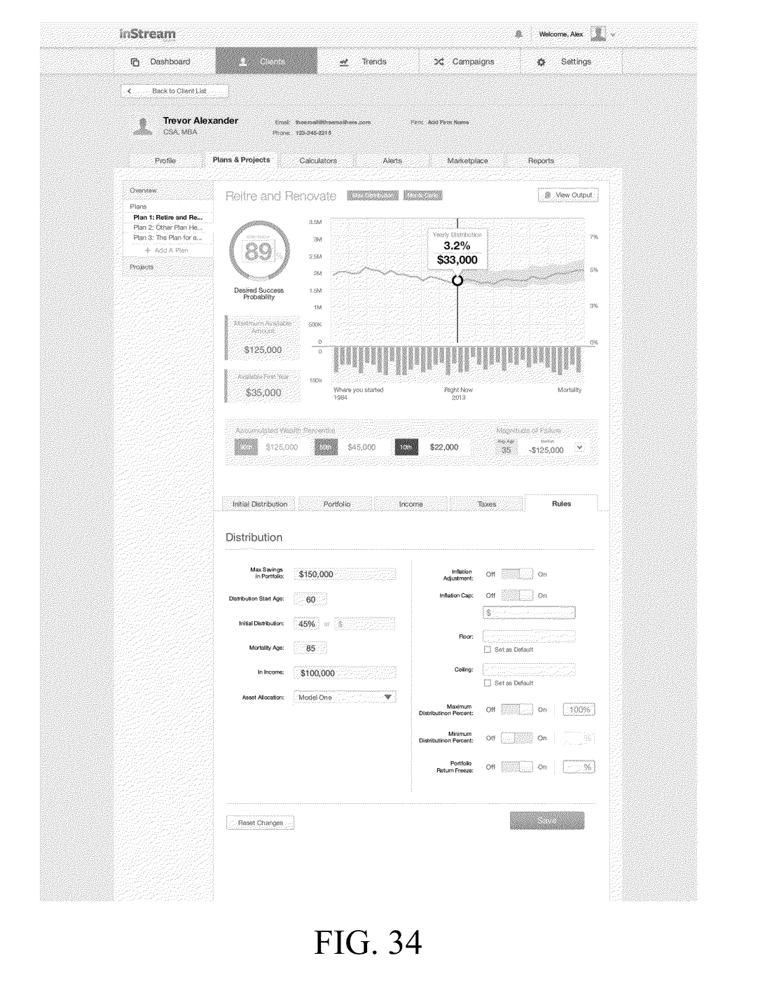

With reference to FIGS. 33 and 34, in an embodiment, the disclosed system and method includes a desired distribution planning module. The desired distribution planning module analyzes a clients' forward looking situation, and using dynamic distribution rules, determines the probability that a client will be able to accomplish their stated spending objectives.

In an embodiment, a sustainable distribution plan analyzes a client's forward looking situation, and using dynamic distribution rules, determines the maximum amount that can be spent each year of the analysis period with a specified probability of success.

### Client Portal

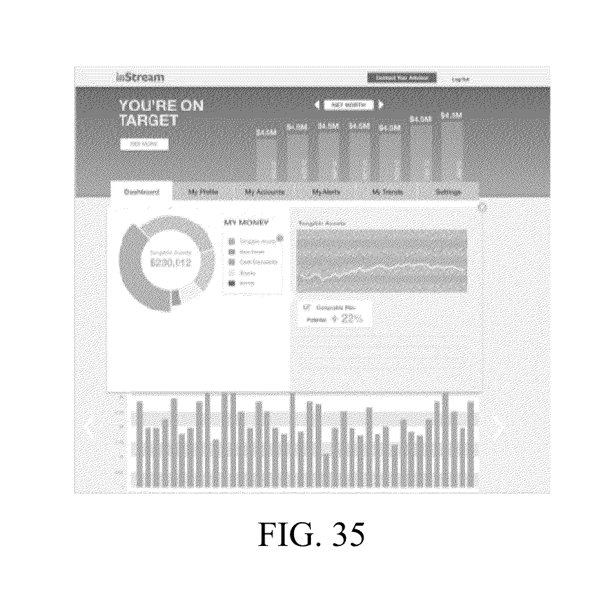

With reference to FIG. 35, in an embodiment, the disclosed system and method provides a dynamically configurable client portal allows advisors to deliver a virtual financial advisory experience to their clients. This provides the advisor with the ability to determine the level of interactivity and data access that is available for their clients and vary that interactivity and data access between clients of different size, sophistication, age and other key demographics. Through the client portal, advisors and their clients can collaborate and coordinate services. The disclosed system and method can facilitate the workflows around many distinct processes, such as opening investment accounts or applying for a mortgage.

The disclosed system and method can be configured to incorporate form filling, sending, receiving, archiving, e-signature, and even vendor reviews. For example, these functions can be incorporated into the opportunity analysis and proactive notification aspects of the system. All of this further feeds into the business intelligence that helps drive peer planning, marketplace, and even practice management and social engagement (e.g., identifying trends in client pain points and success stories).

### Funded Ratio

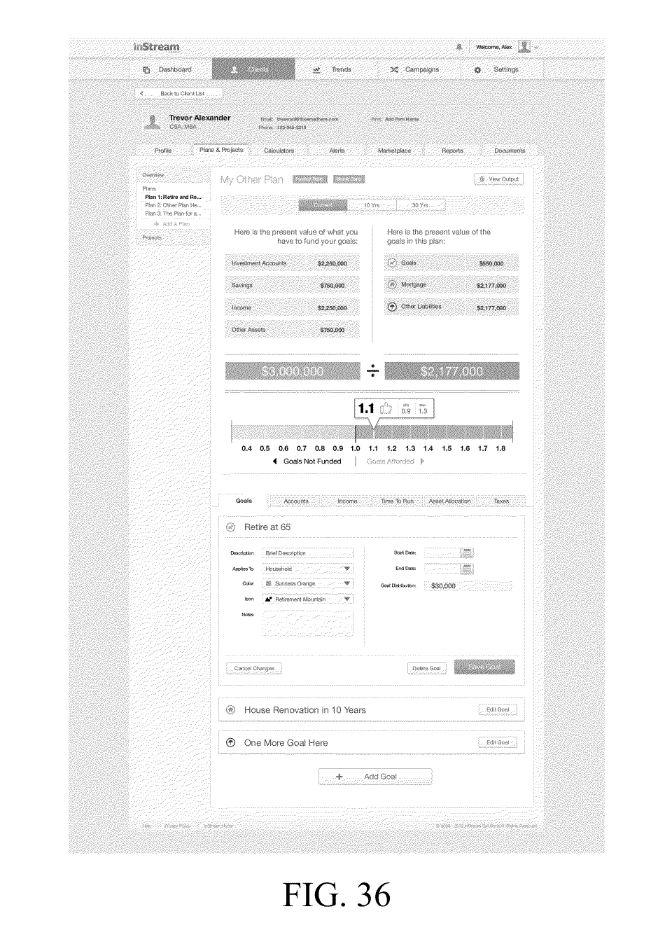

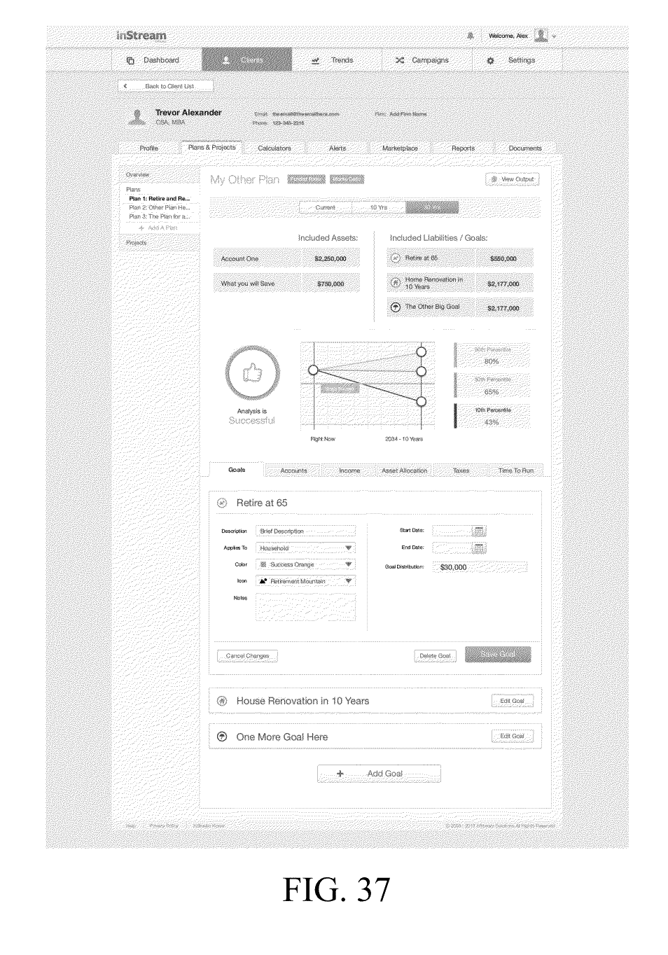

With reference to FIGS. 36 and 37, the funded ratio is determined by comparing the discounted value of a set of assets and a set of liabilities. The discount rate can be set at either a system level or a user defined level. The funded ratio can also be determined at an arbitrary point in the future by using forward looking analysis, and discounting the assets and liabilities from that point forward. The funded ratio can be used in many ways, including, but not limited to: asset allocation decision, annuitization decision, insurance analysis, spending analysis, and other decisions inherent in the wealth management process.

At least some aspects disclosed can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A computer program product for providing an integrated financial advisor platform, the computer program product comprising:
a non-transient computer usable medium having computer readable program code embodied in the computer usable medium for causing an application program to execute on a computer system, the computer readable program code means comprising code to execute a method comprising:
a. on a daily basis, automatically performing a comprehensive review for each of a plurality of a financial advisor's clients;
b. on a daily basis, automatically generating an updated financial plan based on the comprehensive review;
c. on a daily basis, generating a series of alerts based on the comprehensive review, said alerts indicating to an advisor which of said financial advisor's clients should be contacted;
d. transmitting said series of alerts to said financial advisor.
